(19) United States
(12) Patent Application Publication
(10) Pub. No.: US 2005/0215426 A1
(43) Pub. Date: Sep. 29, 2005

(54) Esterification catalyst and process therewith

(76) Inventor: Donald Edward Putzig, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/810,403

(22) Filed: Mar. 26, 2004

(51) Int. Cl. B01J 31/00

(52) U.S. Cl. 502/150; 502/152; 502/155; 502/162; 556/51

(57) ABSTRACT

A composition and process for using the composition are disclosed. The composition comprises, or is produced from, a titanium compound, a phosphorus-containing ester, and optionally a solvent. The titanium compound can be a titanium chelate comprising or produced from a tetraalkyl titanate and a complexing agent. The composition can further comprises a hypophosphorous acid, its salt, or both. The process comprises contacting, in the presence of the composition, a carbonyl compound with an alcohol. Also disclosed is a process, which comprises contacting a carbonyl compound and an alcohol, optionally in the presence of a catalyst to produce an oligomer and contacting the oligomer with a phosphorus-containing ester in which the catalyst can be one that catalyzes esterification or transesterification or polycondensation.

### FIELD OF INVENTION

This invention relates to a catalyst composition comprising a titanium compound and a phosphorus-containing ester and to a process therewith.

### BACKGROUND OF THE INVENTION

Polyesters such as, for example, polyethylene terephthalate, polytrimethylene terephthalate and polybutylene terephthalate, are a class of important industrial polymers. They are widely used in thermoplastic fibers, films, and molding applications.

Polyesters can be produced by transesterification of a dialkyl terephthalate ester with a glycol followed by polycondensation or by direct esterification of terephthalic acid with the selected glycol followed by polycondensation.

Antimony, in the form of a glycol solution of antimony oxide, is frequently used as catalyst in the polyester process. However, antimony forms insoluble antimony complexes that plug fiber spinnerets and leads in fiber spinning to frequent shutdowns to wipe spinnerets clean of precipitated antimony compounds. The antimony-based catalysts are also coming under increased environmental pressure and regulatory control, especially in food contact applications.

Organic titanates, such as tetraisopropyl and tetra n-butyl titanates, are known to be effective catalysts for producing polyester and frequently are the catalyst of choice. However, these catalysts tend to generate a significant amount of yellow discoloration when used as polyesterification catalysts. Additionally, many organic titanate catalysts are also substantially insoluble in a polymerization mixture thereby creating non-uniform distribution of catalyst in the mixture.

Water compatible titanates, such as titanium bis-ammonium lactate, bis-triethanolamine titanate or titanium sodium citrate also generate significant yellow discoloration in the resultant polymer. WO 99/28033 discloses an organometallic compound for producing an ester, which comprises reaction product of an orthoester of titanium, zirconium, or aluminum, an alcohol containing at least two hydroxyl groups, an organophosphorus compound, and a base. When used as polyesterification catalyst, however, it was found that the organometallic compound also generates undesirably significant yellow discoloration in the final product. If the polymer is produced by solid state polymerization, the yellow discoloration becomes more apparent.

Therefore, there is an increasing need for developing a new catalyst that can be substantially soluble in a glycol, is efficient, produces a polymer with reduced color, exhibits good catalytic activity, and is environmentally friendly.

### SUMMARY OF THE INVENTION

A composition comprises, or is produced from, titanium or a titanium compound, a phosphorus-containing ester, and optionally, hypophosphorous acid or its salt, or a solvent.

A process, which can be used for, for example, producing an ester or polyester is provided. The process comprises contacting, in the presence of a catalyst composition, a carbonyl compound with an alcohol. The catalyst composition can be the same as that disclosed above.

Also provided is a process, which can be used for producing an ester or polyester. It comprises contacting a carbonyl compound, optionally in the presence of a catalyst, with an alcohol to produce a product comprising an oligomer and contacting the product with a phosphorus-containing ester wherein the catalyst can be any esterification or transesterification or polycondensation catalyst.

### DETAILED DESCRIPTION OF THE INVENTION

The composition of this invention is preferably substantially soluble in a solvent. The term “substantially” means more than trivial. It is preferred that the composition be completely soluble in the solvent. However, a substantial portion of the composition can also be suspended or dispersed in the solvent. The composition can also be a stable solution in a solvent such as, for example, water, an alcohol, or combinations thereof. The term “stable solution” means a solution remains solution without substantial precipitation or suspension or dispersion of a solute at room temperature (about 25° C.) for at least about 1 day, or 5 days, or even 10 days.

The composition can comprise, consist essentially of, consist of a titanium compound, or be produced from, a titanium compound, a phosphorus-containing ester, and optionally hypophosphorous acid or a salt thereof, or a solvent, or both.

An example of titanium compound is a titanium chelate comprising or produced from a tetraalkyl titanate and a complexing agent. Tetraalkyl titanates, also referred to as titanium tetrahydrocarbyloxides, include those having the general formula Ti(OR)₄ where each R is individually selected from an alkyl, cycloalkyl, alkaryl, hydrocarbyl radical containing from 1 to about 30, or 2 to about 18, or 2 to 12 carbon atoms per radical and each R can be the same or different. Tetraalkyl titanates in which the hydrocarboxyl group contains from 2 to about 12 carbon atoms per radical which is a linear or branched alkyl radical are relatively inexpensive, readily available, and effective in forming a solution. Suitable tetraalkyl titanates include, but are not limited to, titanium tetraethoxide, titanium tetrapropoxide, titanium tetraisopropoxide, titanium tetra-n-butoxide, titanium tetrahexoxide, titanium tetra 2-ethylhexoxide, titanium tetraoctoxide, and combinations of two or more thereof.

A titanium compound can also be combined with a zirconium compound, which has the formula of Zr(OR)₄ where R is the same as disclosed above, to produce a mixture comprising a titanium compound and a zirconium compound. Examples of zirconium compounds include, but are not limited to, zirconium tetraethoxide, zirconium tetrapropoxide, zirconium tetraisopropoxide, zirconium tetra-n-butoxide, zirconium tetrahexoxide, zirconium tetra 2-ethylhexoxide, zirconium tetraoctoxide, and combinations of two or more thereof. The molar ratio of Ti/Zr can be in the range of from about 0.001:1 to about 10:1.

Suitable tetraalkyl titanates can be produced by, for example, mixing titanium tetrachloride and an alcohol in the presence of a base, such as ammonia, to form a tetraalkyl titanate. The alcohol can be ethanol, n-propanol, isopropanol, n-butanol, or isobutanol. Tetraalkyl titanates thus produced can be recovered by removing by-product ammonium chloride by any means known to one skilled in the art such as filtration followed by distilling the tetraalkyl titanates from the reaction mixture. This process can be carried out at a temperature in the range of from about 0 to about 150° C. Titanates having longer alkyl groups can also be produced by transesterification of those having R groups up to C₄ with alcohols having more than 4 carbon atoms per molecule.

Examples of commercially available tetraalkyl titanates include, but are not limited to, TYZOR® TPT and TYZOR® TBT (tetra isopropyl titanate and tetra n-butyl titanate, respectively) available from DuPont (E. I. du Pont de Nemours and Company, Wilmington, Del., USA).

A suitable complexing agent can be one or more hydroxycarboxylic acids, alkanolamines, and aminocarboxylic acids. For example, a complexing agent can be an α-hydroxycarboxylic acid, alkanolamine, or α-aminocarboxylic acid in which the hydrocarbyl group or alkyl group has 1 to about 15, preferably 1 to 10 carbon atoms per group, and combinations of two or more thereof. Examples of suitable complexing agents include, but are not limited to, lactic acid, glycolic acid, citric acid, tartaric acid, malic acid, diethanolamine, triethanolamine, tetrahydroxyisopropylethylenediamine, glycine, bis-hydroxyethyl glycine, hydroxyethyl glycine, and combinations of two or more thereof.

Titanium chelate can be produced by any methods well known to one skilled in the art or is commercially available. Example of commercially available titanium chelate include those available from DuPont such as, for example, TYZOR®LA (titanium bis-ammonium lactate), TYZOR®AA (bis-acetylacetonate titanate), TYZOR®DC (bis-ethyl acetoacetate titanate), TYZOR®TE (bis-triethanolamine titanate), or combinations of two or more thereof.

Phosphorus-containing ester refers to an ester containing phosphorus in the molecule and includes, but is not limited to, a phosphite ester containing no free P—OH groups. Such esters include a tris-phosphite ester or diphosphonite ester. Specific examples of phosphorous-containing esters include, but are not limited to, tris-alkyl and aryl phosphites or aryl diphosphonite esters such as trimethyl phosphite; triethyl phosphite; tributyl phosphite; tri-isopropylphosphite; trisdodecyl phosphite; trinonyldecyl phosphite; triphenylphosphite; phosphorous acid, [1,1′-biphenyl]-4,4′-diylbis-,tetrakis(2,4-bis(1,1-dimethylethyl)phenyl)ester; (tris-(2,4-di-t-butyl) phosphite; tri(ethylene glycol) phosphite; tri(propylene glycol) phosphite; tri(butylene glycol) phosphite; or combinations of two or more thereof. A phosphorus-containing ester can also be introduced to other components of the composition during polycondensation stage. That is, it can be combined with other components and an oligomer as disclosed below.

Hypophosphorous acid or its salt has the formula of H₂POM in which M is hydrogen, ammonium ion, a metal ion, or combinations of two or more thereof and the phosphorus atom is bonded to two hydrogen atoms. The metal ion can be any metal ion such as an alkali metal ion. The hypophosphorous acid or its metal salt such as sodium hypophosphite can be commercially available as an aqueous solution.

Examples of solvent is water or an alcohol having the formula of R¹(OH)ₙ, an alkylene glycol of the formula (HO)ₙA(OH)ₙ, a polyalkylene glycol or alkoxylated alcohol having the formula of R¹O[CH₂CH(R¹)O]ₙH, or combinations of two or more thereof in which each R¹ can be the same or different and is a hydrocarbyl radical having 1 to about 10 carbon atoms per radical. R¹ can be an alkyl radical. A can be an alkylene radical having 2 to about 10 carbon atoms per molecule. Each n can be the same or different and is independently a number in the range of from 1 about to about 10. Examples of solvents include, but are not limited to, water, ethanol, propanol, isopropanol, butanol, ethylene glycol, propylene glycol, isopropylene glycol, butylene glycol, 1-methyl propylene glycol, pentylene glycol, diethylene glycol, triethylene glycol, 2-ethyl hexanol, and combinations of two or more thereof.

Alternatively, the solvent can be that which is formed on reaction of the tetraalkyltitanate with the complexing agent such as, for example, isopropyl alcohol from tetraisopropyltitanate or n-butyl alcohol from tetra n-butyltitanate.

The molar ratio of the complexing agent to tetraalkyl titanate, can be any effective ratio that can substantially prevent the precipitation of the titanium compound in the presence of a solvent. Generally, the ratio can be in the range of from about 1:1 to about 10:1, or about 1:1 to about 7:1, or 1:1 to 4:1. The molar ratio of hypophosphorous acid or its salt to titanium compound (P:Ti) can be any ratio that, when the composition is used as catalyst to produce a polyester, can reduce the yellowness of the polyester such as, for example, in the range of from about 0.1:1 to about 10:1, or about 0.5:1 to about 7:1, or 1:1 to 4:1. The molar ratio of tris-phosphite or diphosphonite ester to titanium compound (P:Ti) can be any ratio that, when the composition is used as catalyst to produce a polyester, can reduce the yellowness of the polyester such as, for example, in the range of from about 0.1:1 to about 50:1, or about 0.5:1 to about 20:1, or 1:1 to 10:1.

The composition can further comprise a co-catalyst such as aluminum, cobalt, zirconium (as disclosed above), zinc, or a compound comprising one or more of these metals, and combinations of two or more thereof. For example, zinc acetate, zinc chloride, zinc nitrate, zinc sulfate, aluminum chloride, aluminum hydroxide, aluminum acetate, aluminum hydroxychloride, cobaltous acetate tetrahydrate, cobaltous nitrate, cobaltous chloride, cobalt acetylacetonate, cobalt napthenate, cobalt hydroxide, cobalt salicyl salicylate, and combinations of two or more thereof can be uses as co-catalyst.

The catalyst composition can be produced by any means known to one skilled in the art such as, for example, mixing the individual components together. The catalyst composition can also be produced, in addition to water, in a second solvent that is compatible with or does not interfere with an esterification or transesterification or polycondensation reaction. For example, if the catalyst composition is used as a polycondensation catalyst for producing polyethylene terephthalate, the composition can be produced in ethylene glycol; if the catalyst composition is used for producing polybutylene terephthalate, the composition can be produced in 1,4-butanediol; and if the catalyst composition is used for producing polypropylene terephthalate, the composition can be produced in 1,3-propylene glycol.

For example, a complexing agent, a phosphite ester, and tetraalkyl titanate can be first combined, optionally in a solvent, to produce a mixture followed by optionally introducing hypophosphrous acid or its salt or a co-catalyst. The combining can be carried out under an inert atmosphere, such as nitrogen, carbon dioxide, helium, or combinations of two or more thereof to avoid liberating a flammable alcohol, if an alcohol is present because of the exothermic nature of the reaction. Producing the mixture can be stirred and can be carried out at a temperature in the range of from about 0° C. to about 100° C., preferably about 20° C. to about 50° C. Generally any amount of solvent can be used as long as the amount can substantially dissolve the composition and can be in the range of from about 5 to about 50, or about 10 to about 30, or 10 to 20 moles per mole of the titanium compound used in the composition. The quantities of individual components generally can be such that the molar ratio of each component to titanium in the catalyst composition produced is within the range disclosed above.

The composition can be used for producing esters or polyesters using any known melt or solid state techniques by promoting esterification, transesterification, polycondensation, or combinations thereof.

A process that can be used in, for example, the production of an ester or polyester is provided. The process comprises contacting, in the presence of a catalyst composition as disclosed above, a carbonyl compound with an alcohol.

Any carbonyl compound, which when combined with an alcohol, can produce an ester or polyester can be used. Generally, such carbonyl compounds include, but are not limited to, acids, esters, amides, acid anhydrides, acid halides, salts of carboxylic acid oligomers or polymers having repeat units derived from an acid, or combinations of two or more thereof. An example of acid is a carboxylic acid or salt or ester thereof.

An example process for producing an ester or polyester comprises, consists essentially of, or consists of contacting a reaction medium with a composition disclosed above in the first embodiment of the invention. The reaction medium can comprise, consist essentially of, or consist of an alcohol and either (1) an organic acid, a salt thereof, an ester thereof, or combinations thereof or (2) an oligomer having repeat units derived from an organic acid or ester.

The organic acid or ester thereof can have the formula of R²COOR² in which each R² independently can be (1) hydrogen, (2) hydrocarboxyl radical having a carboxylic acid group at the terminus, or (3) hydrocarbyl radical in which each radical has 1 to about 30, carbon atoms per radical which can be alkyl, alkenyl, aryl, alkaryl, aralkyl radical, or combinations of two or more thereof, or (4) combinations of two or more thereof. For example, an organic acid can have the formula of HO₂CA¹CO₂H in which A¹ is an alkylene group, an arylene group, alkenylene group, or combinations of two or more thereof. Each A¹ has about 2 to about 30, or about 3 to about 25, or about 4 to about 20, or 4 to 15 carbon atoms per group. Examples of suitable organic acids include, but are hot limited to, terephthalic acid, isophthalic acid, napthalic acid, succinic acid, adipic acid, phthalic acid, glutaric acid, acrylic acid, oxalic acid, benzoic acid, maleic acid, propenoic acid, and combinations of two or more thereof. Examples of suitable esters include, but are not limited to, dimethyl adipate, dimethyl phthalate, dimethyl terephthalate, methyl benzoate, dimethyl glutarate, and combinations of two or more thereof.

Examples of carboxylic acid metal salts or esters thereof includes a 5-sulfo isophthalate metal salt and its ester having the formula of (R³O₂C)₂ArS(O)₂OM¹ in which each R³ can be the same or different and is hydrogen or an alkyl group containing 1 to about 6, or 2, carbon atoms. Ar is a phenylene group. M¹ can be an alkali metal ion such as sodium. An example of the ester is bis-glycolate ester of 5-sulfo isophthalate sodium salt.

Any alcohol that can esterify an acid to produce an ester or polyester can be used in the present invention. Examples of suitable alcohols include, but are not limited to, ethanol, propanol, isopropanol, butanol, ethylene glycol, propylene glycol, isopropylene glycol, butylene glycol, 1-methyl propylene glycol, pentylene glycol, diethylene glycol, triethylene glycol, 2-ethyl hexanol, and combinations of two or more thereof.

When the carbonyl compound includes a 5-sulfo isophthalate metal salt or its ester as disclosed above, the alcohol can be ethylene glycol, propylene glycol, isopropylene glycol, butylene glycol, 1-methyl propylene glycol, pentylene glycol, diethylene glycol, triethylene glycol, 1,6-hexanediol, cyclohexyl-1,4-bismethanol, and combinations of two or more thereof. The contacting of a 5-sulfo-isophthalate metal salt or its ester with a glycol produces a bis-glycolate ester of 5-sulfo isophthalate metal salt.

The contacting of the carbonyl compound and alcohol can be carried out by any suitable means. For example, the carbonyl compound and alcohol can be combined before being contacted with the catalyst. For example, the catalyst can be dispersed in an alcohol by any suitable means such as mechanical mixing or stirring to produce a dispersion followed by combining the dispersion with (1) a carbonyl compound and (2) an alcohol under a condition sufficient to effect the production of a ester or polyester.

An oligomer can have a total of about 1 to about 100, or about 2 to about 10 repeat units derived from a carbonyl compound and alcohol.

Any suitable condition to effect the production of an ester or polyester can include a temperature in the range of from about 150° C. to about 500° C., preferably about 200° C. to about 400° C., and most preferably 250° C. to 300° C. under a pressure in the range of from about 0.001 to about 1 atmosphere for a time period of from about 0.2 to about 20, preferably about 0.3 to about 15, and most preferably 0.5 to 10 hours.

The molar ratio of the alcohol to carbonyl compound can be any ratio so long as the ratio can effect the production of an ester or polyester. Generally the ratio can be in the range of from about 1:1 to about 10:1, or about 1:1 to about 5:1, or 1:1 to 4:1.

The catalyst, expressed as Ti, can be present in the range of about 0.0001 to about 50,000, or about 0.001 to about 10,000, or 0.001 to 1000 ppmw, parts per million by weight (ppmw) of the medium comprising carbonyl compound and alcohol. A co-catalyst disclosed above, if used, can also be present in the same range (expressed as Zr, Zn, Al, or Co). Other ingredients such as conventional esterification and transesterification catalysts (e.g., manganese) and those enhancing catalyst stability or performance may be introduced to the production process concurrent with, or following, introduction of the composition disclosed herein.

Also disclosed is a process that can be used to reduce the formation of color of polyester. The process can comprise contacting a carbonyl compound, optionally in the presence of a catalyst, with an alcohol to produce an oligomer and contacting the oligomer with a phosphorus-containing ester. The carbonyl compound, alcohol, oligomer, and phosphorus-containing ester can be the same as those disclose above. Any catalysts known to catalyze esterification or transesterification or polycondensation can be used in the process. Examples of such catalyst include antimony, manganese, cobalt, titanium, zirconium, zinc, aluminum or combinations thereof. Generally, a phosphorus-containing ester can be introduced to a polyester process after an oligomer is produced such as during polycondensation stage. Because the production of oligomer and polyester process are well known to one skilled in the art, the description of which is omitted herein for the interest of brevity.

The following Examples are provided to further illustrate the present invention and are not to be construed as to unduly limit the scope of the invention. All TYZOR® products were obtained from DuPont disclosed above.

### EXAMPLES

### Example 1

The following solutions or mixtures were prepared by adding TYZOR®LA and phosphite ester, along with any additives shown in Table 1, to 240 g of ethylene glycol by manual stirring at room temperature (about 25° C.). TYZOR®LA is titanium bis ammonium lactate. The catalysts are produced as follows: Catalyst 1, TYZOR®LA and zinc acetate (10 ppm Ti, 80 ppm Zn) in 120 g ethylene glycol solution, 86 ppm Co (from Co acetate) and 45 ppm P (from phosphoric acid) in 120 g ethylene glycol solution added to TPA oligomer (see Example 2); Catalyst 2, Sb glycolate (230 ppm Sb) in 120 g ethylene glycol and 52 ppm Co and 27 ppm P as in 120 g ethylene glycol; Catalyst 3, same as catalyst 1 except tris-butylphosphite (final 25 ppm P) was added to TYZOR®LA ethylene glycol solution; Catalyst 4, Same as catalyst 1 except 5 ppm Ti and 40 ppm Zn; Catalyst 5; Same as catalyst 1 except tris-butylphosphite (final 25 ppm P) was added to TYZOR®LA ethylene glycol solution and no H₃PO₄; and Catalyst 6, Same as catalyst 1 except 52 ppm Co. The composition is summarized as in Table 1.

TABLE 1

| | Ti | Sb | P (P ester) | Zn | | P (H₃PO₄) |
|---|---|---|---|---|---|---|
| Catalyst | (ppm) | (ppm) | (ppm) | (ppm) | Co (ppm) | (ppm) |
| 1 | 10 | 0 | 0 | 80 | 86 | 45 |
| 2 | 0 | 230 | 0 | 0 | 52 | 27 |
| 3 | 10 | 0 | 25 | 80 | 86 | 45 |
| 4 | 5 | 0 | 0 | 40 | 86 | 45 |
| 5 | 10 | 0 | 25 | 80 | 86 | 0 |
| 6 | 10 | 0 | 25 | 80 | 52 | 0 |

### Example 2

A 1-liter resin kettle was provided with a Jiffy Mixer agitator rotating at 40 rpm, a thermocouple, condenser and nitrogen sweep. All of the catalyst shown in Table 1, 115 ml of ethylene glycol, and 400 g of terephthalic acid oligomer (TPA oligomer, produced by the process disclosed in U.S. Pat. No. 6,066,714, column 8, line 5-22, the entire disclosure of the U.S. patent is incorporated herein by reference). The agitator was turned on and the temperature increased to 275° C. over a period of about 2.5 hours. The contents were polymerized by holding under agitation at 275° C. and a pressure of 120 mm Hg for 20 minutes, and at 280° C. and a pressure of 30 mm Hg for an additional 20 minutes. The contents were then held under agitation at 285° C. at 1 to 2 mm Hg pressure for a time sufficient to reach 15 ounce-inch (0.106 Newton-meter) torque as measured by an Electro-Craft Motomatic torque controller. The time for this step was recorded as the Finish Time, and varied with the catalyst used. The polymer melt was then poured into a water bath to solidify the melt, and the resultant solid annealed at 150° C. for 12 hours and ground to pass through a 2 mm filter for color measurements using the previously described spectrophotometer. Results comparing the color as measured spectrophotometrically are given in Table 2 below.

Color of the resulting polymer was measured in terms of the L-value and b-value, using an instrument such as SP-78 Spectrophotometer. The L-value shows brightness, with the greater the numerical value showing higher (desirable) brightness. A value of 78 or more would be considered good. The b-value shows the degree of yellowness, with a higher numerical value showing a higher (undesirable) degree of yellowness. Generally a b value below 7 can be considered good. The a value represents degree of redness, a higher positive a is redder, a lower negative a is greener.

Table 2 shows that catalyst 1 performed similarly to Sb standard (Catalyst 2) in b color generation in base chip, SSP chip and was defensive against Sb standard in b color retention in plaques made from SSP (solid state polymerization) chip. Addition of 25 ppm P from tris-butylphosphite (Catalyst 3) improved b color of base chip and SSP chip and resulted in better retention of b color in plaques made from SSP chip. Attempts to improve b color performance of Catalyst 1 by reducing the level of Ti and Zn (Catalyst4) resulted in loss of catalytic activity, which required higher polycondensation (PC) temperatures to reach desired degree of polymerization. The higher PC temperature resulted in higher b color for base chip and SSP chip and poorer b color retention in plaques made from SSP chip. Elimination of phosphoric acid from Catalyst 1, resulted in more active catalyst (Catalysts 5 and 6), which required less PC time and resulted in improved b color performance.

TABLE 2¹

| | base | SSP | PC | PC time | Plaque | Plaque | Plaque |
|---|---|---|---|---|---|---|---|
| Run | b* | b* | Temp(° C.) | (min) | L* | a* | b* |
| 1 | 3.01 | 3.01 | 280 | 130 | 82.24 | −0.66 | 11.66 |
| 2 | 1.68 | 3.41 | 300 | 106 | 79.07 | −1.38 | 10.4 |
| 3 | 2.2 | 1.59 | 280 | 139 | 83.48 | −0.5 | 8.55 |
| 4 | 6.82 | 7.98 | 300 | 132 | 82.77 | −3.46 | 18.09 |
| 5 | −1.98 | −0.13 | 280 | 111 | 81.64 | 0.13 | 7.51 |
| 6 | 0.1 | 2.77 | 280 | 117 | 83.67 | −1.18 | 10.04 |

¹b color of chip after polycondensation;
SSP b* represents b color of base chip after solid state polymerization;
Plague L*, Plague a and Plague b represent L, a and b color of plaques made by extruding SSP chip and casting ¼″ thick films of polymer.

### Example 3

A separate run was carried out using the 1-liter autoclave disclosed in Example 2. The catalyst solutions described below were added, along with a solution containing 0.1055 g of cobalt acetate and 0.412 g of 85% phosphoric acid in 120 g of ethylene glycol, to 500 g of TPA oligomer; except that Catalyst 10 was added along with a solution of 0.886 g of cobalt acetate and 0.301 g of 85% phosphoric acid in ethylene glycol to 500 g of TPA oligomer. The following catalysts were prepared; Catalyst 7, 0.0305 g TYZOR®LA, 0.0834 g zinc acetate, 0.1471 g of aluminum chloride hydroxide (Ultrion 8187 obtained from ONDEO Nalco Co.) and 0.25 g of Sandostab P-EPQ (phosphorous acid [1,1′-biphenyl]-4,4′-diylbis-,tetrakis(2,4-bis(l,1 -dimethylethyl)phenyl)ester) was dissolved in 120 g of ethylene glycol; Catalyst 8, identical to Catalyst 7, however 0.5 g of Sandostab P-EPQ was used; Catalyst. 9, identical to Catalyst 7 without Sandostab P-EPQ; Catalyst 10, 0.2028 g of antimony glycolate was dissolved in 120 g of ethylene glycol; Catalyst 11, 0.061 g of TYZOR® LA, 0.1334 g of zinc acetate and 0.25 g of Sandostab P-EPQ; Catalyst 12, identical to Catalyst 11, but 0.125 g of Sandostab P-EPQ was used; Catalyst 13, identical to Catalyst 11, but 0.05 g of Sandostab P-EPQ was used; Catalyst 14, identical to Catalyst 11, but 0.1 g of tributyl phosphite was used in place of Sandostab P-EPQ; Catalyst 15, identical to Catalyst 14, but 0.15 g of tributyl phosphite was used; Catalyst 16, identical to Catalyst 14, but 1.5 g of a solution of tri-ethylene glycol phosphite was used instead of tributyl phosphite; Catalyst 17, identical to Catalyst 16, but 1.0 g of a solution of tri-ethylene glycol phosphite was used; Catalyst 18, identical to Catalyst 11, but no phosphite ester was used.

The results are shown below in Table 3, which demonstrate that addition of a trialkylphosphite such as tributylphosphite or triethylene glycol phosphite or a diphosphonite ester such as Sandostab P-EPQ to the catalyst improved b color of the resultant polymers.

TABLE 3^{1,2}

| | | | | Optical Property | | |
|---|---|---|---|---|---|---|
| | | | | color | | |
| Catalyst | Metals | Wt. Ratio | PC time (min) | L | a | b |
| 7 | Ti/Zn/Al/Co/P/P- | 5/50/35/50/26/500 | 50 | 75.18 | −1.2 | 2.37 |
| | EPQ | | | | | |
| 8 | Ti/Zn/Al/Co/P/P- | 5/50/35/50/26/1000 | 130 | 71.47 | −1.88 | 0.6 |
| | EPQ | | | | | |
| 9 | Ti/Zn/Al/Co/P | 5/50/35/50/26 | 30 | 75.1 | −0.89 | 4.64 |
| 10 | Sb/Co/P | 230/42/19 | 75 | 73.79 | −1.74 | 5.03 |
| 11 | Ti/Zn/Co/P/P- | 10/80/50/26/500 | 45 | 76.41 | −1.73 | 1.56 |
| | EPQ | | | | | |
| 12 | Ti/Zn/Co/P/P- | 10/80/50/26/250 | 55 | 72.96 | −1.61 | 2.03 |
| | EPQ | | | | | |
| 13 | Ti/Zn/Co/P/P- | 10/80/50/26/100 | 45 | 74.33 | −1.66 | 3.06 |
| | EPQ | | | | | |
| 14 | Ti/Zn/Co/P/P- | 10/80/50/26/25 | 70 | 78.78 | −1 | 2.7 |
| | TBP | | | | | |
| 15 | Ti/Zn/Co/P/P- | 10/80/50/26/25 | 90 | 78.09 | −0.73 | 0.03 |
| | TBP | | | | | |
| 16 | Ti/Zn/Co/P/P- | 10/80/50/26/25 | 135 | 81.63 | −0.89 | 1.87 |
| | TBPEG | | | | | |
| 17 | Ti/Zn/Co/P/TBP | 10/80/50/26/17 | 60 | 79.21 | −1.31 | 2.16 |
| | EG | | | | | |
| 18 | Ti/Zn/Co/P | 10/80/50/26 | 35 | 76.48 | −1.1 | 6.53 |

¹P in represents phosphorus from phosphoric acid, P-PEQ represents phosphorus from Sandostab P-EPQ (phosphorous acid [1,1′-biphenyl]-4,4′-diylbis-,tetrakis(2,4-bis(1,1-dimethylethyl)phenyl)ester), P-TBP = P from tributyl phosphite and P-TBPEG represents P from triethylene glycol phosphite solution.
²Tri-ethylene glycol phosphite solution was prepared by adding 25 g of tributyl phosphite to 225 g of ethylene glycol followed by heating solution to 115° C. for 1 hour followed by vacuum distillation with a 50 mm vacuum applied to remove 22.7 g n-butanol. The resultant solution contained about 1.36% P as tri-ethylene glycol phosphite.

1. A composition comprising, or produced from, titanium or a titanium compound, a phosphorusontaining ester wherein said phosphorus-containing ester is a phosphite ester, and optionally a solvent wherein said titanium compound is a titanium chelate comprising or produced from a tetraalkyl titanate and a complexing agent; said complexing agent is a hydroxycarboxylic acid, an alkanolamine, an aminocarboxylic acid, or combinations of two or more thereof; and said phosphorus-containing ester contains no free P—OH group.

2. (canceled)

3. A composition according to claim 1 wherein said phosphorus-containing ester is tris-phosphite ester, diphosphonite ester, or combinations thereof.

4. A composition according to claim 1 wherein said phosphorus-containing ester is trimethyl phosphite; triethyl phosphite; tributyl phosphite; tri-isopropylphosphite; trisdodecyl phosphite; trinonyldecyl phosphite; triphenylphosphite; phosphorous acid, [1,1′-biphenyl]-4,4′-diylbis-tetrakis(2,4-bis(1,1-dimethylethyl)phenyl)ester; (tris-(2.4-di-t-butyl) phosphite; triethylene glycol phosphite; tripropylene glycol phosphite; tributylene glycol phosphite; or combinations of two or more thereof.

5. A composition according to claim 1 wherein said complexing agent is an α-hydroxycarboxylic acid, an allanolaniine, an α-aminocarboxylic acid, or combinations of two or more thereof.

6. A composition according to claim 4 wherein said complexing agent is lactic acid, glycolic acid, citric acid, isocitric acid, tartaric acid, malic acid, malonic acid, glycine, hydroxyethyl glycine, bis-hydroxyethyl glycine, or combinations of two or more thereof.

7. A composition according to claim 4 wherein said complexing agent is lactic acid.

8. A composition according to claim 4 wherein said tetraalkyl titanate is tetra isopropyl titanate, tetra n-butyl titanate, or combinations thereof.

9. A composition according to claim 7 wherein said tetraalkyl titanate is tetra isopropyl titanate, tetra n-butyl titanate, or combinations thereof.

10. A composition according to claim 1 wherein said composition further comprises a hypophosphorous acid, its salt, or both.

11. A composition according to claim 4 wherein said composition further comprises a hypophosphorous acid, its salt, or both.

12. A composition according to claim 7 wherein said composition further comprises a hypophosphorous acid, its salt, or both.

13. A composition according to claim 9 wherein said composition further comprises a hypophosphorous acid, its salt, or both.

14. A composition according to claim 9 wherein said composition further comprises sodium hypophosphite.

15. A composition according to claim 9 wherein said titanium compound is TYZOR®LA (titanium bis ammonium lactate).

16. A composition according to claim 3 further comprising a co-catalyst, which is aluminum, cobalt, zirconium, zinc, a compound comprising one or more of these metals, or combinations of two or more thereof.

17. A composition according to claim 8 further comprising a co-catalyst, which is zinc acetate, zinc chloride, zinc nitrate, zinc sulfate, or combinations of two or more thereof.

18. A composition according to claim 15 wherein said stabilizer is tributyl phosphite; phosphorous acid, [1,1′-biphenyl)4,4′-diylbis-;tetrakis(2,4-bis(1,1 -dimethylethyl)phenyl)ester; triethylene glycol phosphite; or combinations of two or more thereof.

19. A composition according to claim 17 wherein said stabilizer is tributyl phosplite; phosphorous acid, [1,1′-biphenyl]-4,4′-diylbis-;tetrakis(2,4-bis(1,1-dimethylethyl)phenyl)ester; triethylene glycol phosphite; or combinations of two or more thereof.

20. A process to produce an ester or polyester comprising contacting, in the presence of a catalyst composition, a carbonyl compound with an alcohol; wherein said composition comprises, or is produced from, a titanium compound, a phosphorus-containing ester wherein said phosphorus-containing ester is a tris-phosphite ester, dinhosphonite ester, or combinations, and optionally a solvent; said titanium compound is a titanium chelate comprising or produced from a tetraalkyl titanate and a complexing agent; said complexing agent is a hydroxycarboxylic acid, an alkanolamine, an aminocarboxylic acid, or combinations of two or more thereof; and said phosphorus-containing ester a phosphite ester containing no free P—OH group.

21. (canceled)

22. A process according to claim 20 wherein said phosphorus-containing ester is trimethyl phosphite; triethyl phosphite; tributyl phosphite; tri-isopropylphosphite; trisdodecyl phosphite; trinonyldecyl phosphite; triphenylphosphite; phosphorous acid, [1,1′-biphenyl]-4,4′-diylbis-tetrakis(2,4-bis(1,1-dimethylethyl)phenyl)ester; (tris-(2,4-di-t-butyl) phosphite; triethylene glycol phosphite; tripropylene glycol phosphite; tributylene glycol phosphite; or combinations of two or more thereof.

23. A process according to claim 20 wherein said complexing agent is an a-hydroxycarboxylic acid, an alkanolamine, an α-aminocarboxylic acid, or combinations of two or more thereof.

24. A process according to claim 22 wherein said complexing agent is lactic acid, glycolic acid, citric acid, isocitric acid, tartaric acid, malic acid, malonic acid, glycine, hydroxyethyl glycine, bis-hydroxyethyl glycine, or combinations of two or more thereof.

25. A process according to claim 22 wherein said complexing agent is lactic acid.

26. A process according to claim 22 wherein said tetraalkyl titanate is tetra isopropyl titanate, tetra n-butyl titanate, or combinations thereof.

27. A process according to claim 25 wherein said tetraalkyl titanate is tetra isopropyl titanate, tetra n-butyl titanate, or combinations thereof.

28. A process according to claim 22 wherein said composition further comprises a hypophosphorous acid, its salt, or both.

29. A process according to claim 27 wherein said composition further comprises a hypophosphorous acid, its salt, or both.

30. A process according to claim 28 wherein said composition further comprises sodium hypophosphite.

31. A process according to claim 27 wherein said carbonyl compound is terephthalic acid or ester thereof and said alcohol is ethylene glycol.

32. A process according to claim 27 wherein said titanium compound is TYZOR®LA (titanium bis ammonium lactate).

33. A process according to claim 26 further comprising a co-catalyst, which is aluminum, cobalt, zirconium, zinc, a compound comprising one or more of these metals, or combinations of two or more thereof.

34. A process according to claim 32 further comprising a co-catalyst, which is zinc acetate, zinc chloride, zinc nitrate, zinc sulfate, or combinations of two or more thereof.

35. A process to reduce the formation of color in a polyester comprising contacting a carbonyl compound, optionally in the presence of a catalyst, with an alcohol to produce a product comprising an oligomer and contacting said product with a phosphorus-containing ester wherein said phosphorus-containing ester is a tris-phosphite ester, diphosphonite ester, or combinations thereof; said carbonyl compound is an organic acid or its salt or its ester or combinations thereof; and said phosphorus-containing ester a phosphite ester containing no free P—OH group.

36. (canceled)

37. A process according to claim 35 wherein said catalyst comprises, or is produced from, a titanium compound, and optionally a solvent; said titanium compound is a titanium chelate comprising or produced from a tetraalkyl titanate and a complexing agent, said oligomer comprises repeat units derived from said carbonyl compound and said alcohol; and said complexing agent is a hydroxycarboxylic acid, an alkanolamine, an aminocarboxylic acid, or combinations of two or more thereof and said phosphorus-containing ester is trimethyl phosphite; triethyl phosphite; tributyl phosphite; tri-isopropylphosphite; trisdodecyl phosphite; trinoxnyldecyl phosphite; triphenylphosphite; phosphorous acid, [1,1′-biphenyl]-4,4′-diylbis-,tetrakis(2,4-bis(1,1-dimethylethyl)phenyl)ester; (tris-(2,4-di-t-butyl) phosphite; triethylene glycol phosphite; tripropylene glycol phosphite; tributylene glycol phosphite; or combinations of two or more thereof.

38. A process according to claim 37 wherein said complexing agent is lactic acid, glycolic acid, citric acid, isocitric acid, tartaric acid, malic acid, malonic acid, glycine, hydroxyethyl glycine, bis-hydroxyethyl glycine, or combinations of two or more thereof.

39. A process according to claim 39 wherein said complexing agent is lactic acid.

40. A process according to claim 37 wherein said tetraalkyl titanate is tetra isopropyl titanate, tetra n-butyl titanate, or combinations thereof.

41. A process according to claim 39 wherein said tetraalkyl titanate is tetra isopropyl titanate, tetra n-butyl titanate, or combinations thereof.

42. A process according to claim 35 wherein said catalyst further comprises a hypophosphorous acid, its salt, or both.

43. A process according to claim 38 wherein said catalyst further comprises a hypophosphorous acid, its salt, or both.

44. A process according to claim 41 wherein said hypophosphorous acid, its salt, or both is sodium hypophosphite.

45. A process according to claim 41 wherein said titanium compound is TYZOR®LA (titanium bis ammonium lactate).

46. A process according to claim 37 further comprising a co-catalyst, which is aluminum, cobalt, zirconium, zinc, a compound comprising one or more of these metals, or combinations of two or more thereof.

47. A process according to claim 45 further comprising a co-catalyst, which is zinc acetate, zinc chloride, zinc nitrate, zinc sulfate, or combinations of two or more thereof.

48. A process according to claim 47 wherein each of said catalyst and said co-catalyst is in a solution in which water or ethylene glycol is solvent.

49. A process according to claim 48 wherein said carbonyl compound is terephthalic acid or ester thereof and said alcohol is ethylene glycol.

50. A process according to claim 49 wherein said stabilizer is tributyl phosphite; phosphorous acid, [1,1 ′-biphenyl]-4,4′-diylbis-,tetrakis(2,4-bis(1,1-dimethylethyl)phenyl)ester; triethylene glycol phosphite; or combinations of two or more thereof.
